(19) United States
(12) Patent Application Publication
(10) Pub. No.: US 2011/0272913 A1
(43) Pub. Date: Nov. 10, 2011

(54) ADJUSTABLE WALKER

(75) Inventor: Harvey Diamond, Armonk, NY (US)

(73) Assignee: Drive Medical Design & Mfg., Port Washington, NY (US)

(21) Appl. No.: 13/103,590

(22) Filed: May 9, 2011

Related U.S. Application Data
(60) Provisional application No. 61/333,089, filed on May 10, 2010.

(51) Int. Cl. A61H 3/00

(52) U.S. Cl. 280/288.2; 135/67

(57) ABSTRACT

An adjustable walker includes first and second side frames. Each side frame includes a front leg defining a fixed end and a free end and a rear leg defining a fixed end and a free end. The legs are coupled to one another at the fixed ends thereof and are extendable between a first position defining a first length and a second position defining a second length greater than the first length. Each leg includes a locking mechanism for releasably fixing the leg in each of the first and second positions. A side brace is coupled to the front and rear legs and includes a side rail extending transversely therebetween. The side brace is moveable along the legs between the fixed ends and the free ends thereof. The side brace includes a latching mechanism for releasably fixing the position of the side brace with respect to the legs.

### CROSS-REFERENCE TO RELATED APPLICATION

The present application claims priority to, and benefit of, U.S. Provisional Patent Application No. 61/333,089 entitled “Adjustable Walker” filed on May 10, 2010, the entire contents of which are hereby incorporated by reference herein.

### BACKGROUND

1. Technical Field

The present disclosure relates to walking aids and, more particularly, to an improved adjustable walker adaptable for use by individuals having varying needs and/or physical characteristics.

2. Background of Related Art

Walkers are commonly used by the elderly, handicapped and infirm to assist such individuals in maintaining their mobility, for example, to exercise and/or to perform daily tasks, without the need of a nurse or aide. Typically, a walking device, or walker, includes four legs that form a frame having an open end to permit the user to stand within the frame, thereby providing support and balance to the individual. Additional features such as handles and/or wheels may also be provided to assist the individual in maneuvering about. Further, walkers may be formed from lightweight materials to increase maneuverability, and/or may be adapted to fold down, or collapse, to allow for easy storage in relatively small spaces, e.g., the trunk of a car.

The exact dimensions and/or configuration of a walker may ultimately depend on the physical characteristics of the individual, e.g., height and weight, or may depend on other factors such as the amount of support and balance heeded and/or the specific condition that requires the use of the walker. Accordingly, an adjustable universal walker capable of adjusting through a range of heights while providing adequate stability and support at each specific height is desirable in that such a walker obviates, the need for medical supply stores, nursing homes, hospitals, and they like to carry multiple walkers, e.g., fixed walkers of varying size and/or adjustable walkers having limited size ranges. In other words, an, adjustable universal walker provides a single walker adaptable for use by the young, elderly, handicapped and/or infirm without sacrificing stability, support, or maneuverability.

### SUMMARY

In accordance with one embodiment of the present disclosure, an adjustable walker is provided. The adjustable walker includes first and second side frames coupled to one another. Each side frame includes a front leg and a rear leg. Each of the front and rear legs defines a fixed end and a free end. The front and rear legs are coupled to one another at the fixed ends thereof. Each of the legs is extendable between a first position defining a first length and a second position defining a second length that is greater than the first length. Each of the legs further includes a locking mechanism for releasably fixing the leg in the first and/or second position. A side brace is coupled to both the front leg and the rear leg and includes a side rail that extends transversely between the legs. The side brace is moveable along at least a portion of the front and rear legs, e.g., up and down the legs, between the fixed ends and the free ends thereof. The side brace includes a latching mechanism for releasably fixing the position of the side brace with respect to the legs.

In one embodiment, each of the legs includes an inner shaft and an outer shaft. The outer shaft is moveable with respect to the inner shaft, e.g., telescopically, between a substantially overlapping position and an extended position for moving the leg between the first and second position.

In another embodiment, the locking mechanism includes a plurality of apertures defined within the outer shaft of each of the legs. The apertures are positioned along a length of the outer shafts. A locking pin is disposed on the inner shaft of each of the legs. The locking pin is releasably engagable within each of the apertures for selectively fixing the position of the inner and outer shafts with respect to one another. In other words, the locking mechanism is configured to selectively fix the height of the legs, once the legs are adjusted to the required height.

In another embodiment, the first end of the outer shaft of each of the legs includes an annular cuff disposed therearound. The side brace may be moved along the legs into position adjacent the annular cuffs. Positioning the side brace adjacent the annular cuffs positions the side brace in a specific pre-determined position along the legs according to the height of the legs, e.g., to provide structural support to the side frame.

In yet another embodiment, the latching mechanism includes first and second portions that are hingable with respect to one another between an open position and a closed position. When moved to the closed position, the first and second portions are annularly positionable about the front or rear leg, e.g., the first and second portions cooperate to surround the leg, to thereby fix the relative position of the side brace with respect to the legs. Further, the latching mechanism may include a locking key for retaining the first and second portions in the closed position.

In still another embodiment, the free ends of the front legs include a wheel coupled thereto for allowing wheeled movement of the walker. Additionally, the first and second side frames may be coupled to one another by a front cross-bar and/or may include a handle portion that fixedly engages the fixed ends of the front and rear legs to one another.

In still yet another embodiment, the front and rear legs are angled with respect to one another. More specifically, the front and rear legs are angled such that the fixed ends of the legs are spaced-apart a first transverse distance, while the free ends of the legs are spaced-apart a second transverse distance that is greater than the first transverse distance.

In another embodiment, the side brace is adjustable between a first position having a first length corresponding to the first transverse distance between the legs and a second position having a second length corresponding to the second transverse distance between the legs. Further, the side brace may be configured for automatic adjustment to define a length corresponding to the transverse distance between the front and rear legs, i.e., the side brace adjusts its length depending on the positioning of the side brace along the legs.

The side brace may include a pair of connectors coupling the side brace to each of the legs. In such an embodiment, the side rail interconnecting the connectors and is moveable with respect to one (or both) of the connectors between a first position corresponding to the first length of the side brace and a second position corresponding to the second length of the side brace. To facilitate adjustment of the side brace, the side rail may include a pin disposed within a slot defined within one of the connectors. The pin is moveable from a first end of the slot to a second end of the slot such that the side rail is moveable between the first position and the second position. Alternatively, the side rail may include an inner portion and an outer portion moveable with respect to the inner portion to facilitate adjustment of the side brace.

In accordance with another embodiment of the present disclose, an adjustable walker is provided. The adjustable walker includes first and second side frames coupled to one another. Each side frame defines a generally “A”-shaped configuration and includes a handle portion, a front leg, a rear leg and a side brace. The front and rear legs are extendable between a first position defining a first height of the side frame and a second position defining a second height of the side frame that is greater than the first height. The side brace is coupled to the legs and extending transversely therebetween. The side brace is moveable with respect to the legs along the height thereof, e.g., up and down the legs. The side brace is adjustable between a first position defining a first length corresponding to a first transverse distance between the legs and a second position defining a second length corresponding to a second transverse distance between the legs. In other words, as the side brace is moved along the legs, the length of the side brace is adjusted to account for the “A”-shaped configuration of the side frames.

In one embodiment, the side brace further includes a latching mechanism for releasably fixing the position of the side brace with respect to the legs.

In another embodiment, the side brace includes a side rail and a pair of connectors. The side rail includes a pin that is disposed within a slot defined within one of the connectors. The pin is moveable from a first end of the slot to a second end of the slot to permit adjustment of the side brace between the first and second positions.

In another embodiment, the side brace includes a side rail having an inner portion and an outer portion that is moveable with respect to the inner portion to permit adjustment of the side brace between the first and second positions.

### BRIEF DESCRIPTION OF THE DRAWINGS

Various embodiments of the presently disclosed walker are described herein with reference to the drawings wherein:

FIG. 1 is a front, perspective view of one embodiment of a walker in accordance with the present disclosure;

FIG. 2 is a front, perspective view of another embodiment of a walker in accordance with the present disclosure;

FIG. 3 is an enlarged, side view of a pair of adjustable legs for use with the walker of FIG. 1 or FIG. 2, shown with parts separated;

FIG. 4 is a side view of the walker of FIG. 1 shown in a first position;

FIG. 5 is a side view of the walker of FIG. 1 shown in a second position;

FIG. 6 is an enlarged, side view of one embodiment of an adjustable side brace for use with the walker of FIG. 1 or FIG. 2;

FIG. 7 is a side, perspective view of a latching mechanism of the side brace of FIG. 6;

FIG. 8A is a top view of the latching mechanism of FIG. 7 shown in an open position;

FIG. 8B is a top view of the latching mechanism of FIG. 7 shown in a closed, or locked, position;

FIG. 9 is an enlarged, side view of another embodiment of an adjustable side brace for use with the walker of FIG. 1 or FIG. 2; and

FIG. 10 is an enlarged, side view of a latching mechanism for use with the side brace of FIG. 9.

### DETAILED DESCRIPTION

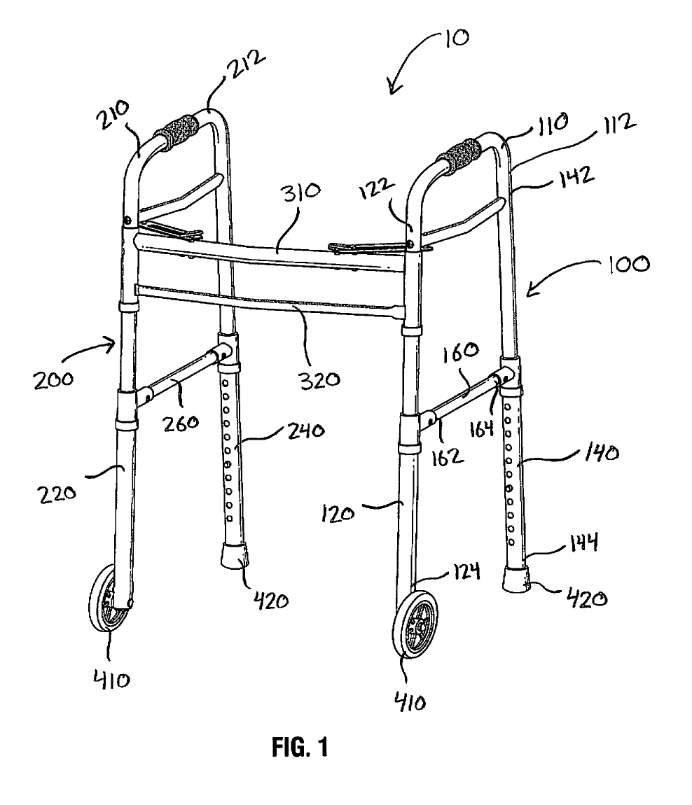

Turning now to FIG. 1 a walking aid, or walker provided in accordance with an embodiment of the present disclosure is shown generally identified by reference numeral 10. Walker 10 includes a pair of side frames 100, 200 coupled to one another by a front cross-bar 310 and a front support member 320. The side frames 100, 200, front cross-bar 310 and front support member 320 define an open-frame configuration to permit a user to stand at least partially within the frame of walker 10 during use, thereby providing the user with additional stability, support, and balance.

Side frame 100 of walker 10 includes a handle portion 110 disposed at a top end 112 thereof to facilitate grasping and maneuvering of walker 10 by the user. Extending downwardly from handle portion 110 are front and rear legs 120, 140, respectively, that define a generally “A”-shaped, or oblique configuration. More specifically, each leg 120, 140 is coupled to handle portion 110 at a respective fixed end 122, 142 thereof and extends downwardly therefrom to a respective free end 124, 144 thereof. Further, each leg 120, 140, is adjustable between a first position, defining a first length, or height, and a second position defining a second length, or height, such that, as will be described in greater detail below, a height of walker 10 may be adjusted according to the specific physical characteristics and/or needs of the user.

With continued reference to FIG. 1, a side brace 160 is interdisposed between front and rear legs 120, 140, respectively. More specifically, side brace 160 is coupled to front leg 120 at a first end 162 thereof and is coupled to rear leg 140 at a second end 164 thereof such that side brace 160 extends transversely between front and rear legs 120, 140, respectively, of side frame 100 of walker 10 to provide structural support and stability to walker 10. Further, as will be described in greater detail below, side brace 100 is selectively translatable with respect to front and rear legs 120, 140, respectively, i.e., upwardly and downwardly relative to legs 120, 140, to maintain the structural integrity and stability of walker 10 when legs 120, 140, are disposed in the first position, the second position, or any of the intermediate positions therebetween.

Side frame 200 of walker 10 is substantially similar to side frame 100, discussed above, and includes a handle portion 210 disposed at a top end 212 thereof, front and rear adjustable legs 220, 240, respectively, extending downwardly from handle portion 212, and an adjustable side brace 260 coupled to each of front and rear legs 220, 240, respectively, and extending therebetween.

As shown in FIG. 1, front legs 120, 220 of respective side frames 100, 200 each include a wheel 410 disposed at a respective free end 124, 224 and on an outer side thereof to facilitate movement of walker 10 across relatively planar surfaces. Rear legs 140, 240, of respective side frames 100, 200, on the other hand, include caps, or stoppers, e.g., rubber stoppers 420, respectively, to prevent slippage, to absorb some of the forces associated with lifting and placing walker 10, and to reduce the wear and tear on side frames 100, 200.

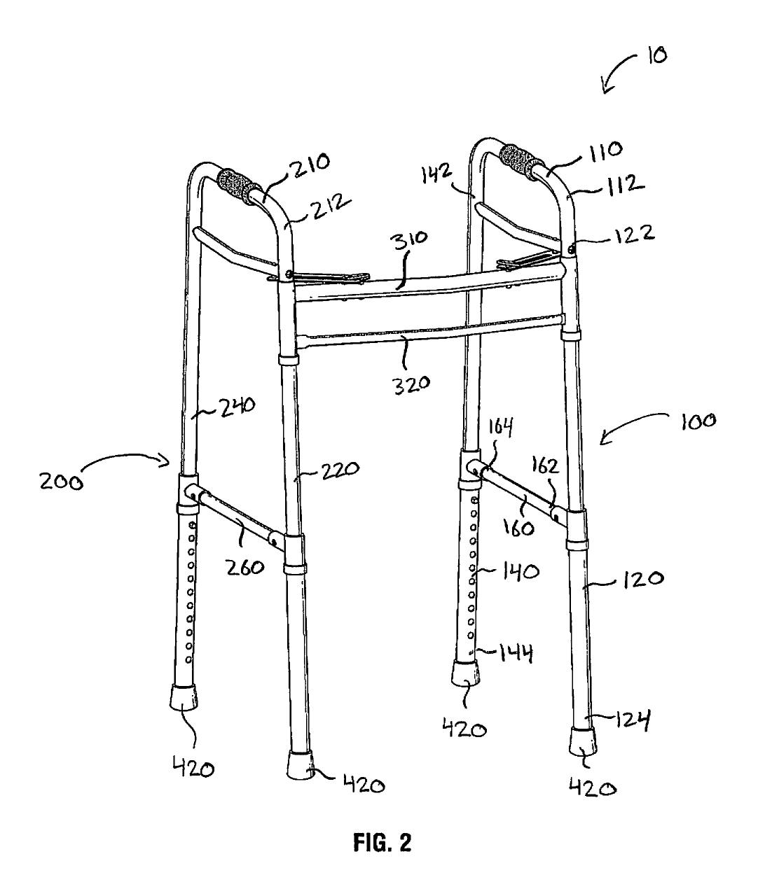

Alternatively, as shown in FIG. 2, walker 10 may include a pair of stoppers 400 disposed at free ends 124, 224 of front legs 120, 220, of side frames 100, 200, respectively (as opposed to wheels 410 shown in FIG. 1). Such a configuration may be advantageous for use on uneven surfaces, for other reasons according to the particular condition and/or characteristics of the user, or may simply be a preference of the user. Further, it is envisioned that wheels 410 and/or stoppers 420 of side frames 100, 200 may be replaceable with one another such that the user may select the desired component, although fixed wheels 410 and/or stoppers 420 are also contemplated.

Referring now to FIGS. 1-2, and initially to FIG. 1, front and rear legs 120, 140, respectively, of side frame 100 and front and rear legs 220, 240, respectively, of side frame 200 are disposed in a first position defining a first height, e.g. for smaller users. As shown in FIG. 2, front and rear legs 120, 140, respectively, of side frame 100 and front and rear legs 220, 240, respectively, of side frame 200 are disposed in a second position defining a second, greater height, e.g., for taller users. In conjunction with the extension of legs 120, 140 and 220, 240 of respective side frames 100, 200, i.e., from the position of FIG. 1 to the position of FIG. 2, side braces 160, 260, of side frames 100, 200, respectively, are adjusted, i.e., translated downwardly, such that side braces 160, 260, remain generally centrally disposed with respect to side frames 100, 200, thereby maintaining the structural support and stability of walker 10 regardless of the height of side frames 100, 200.

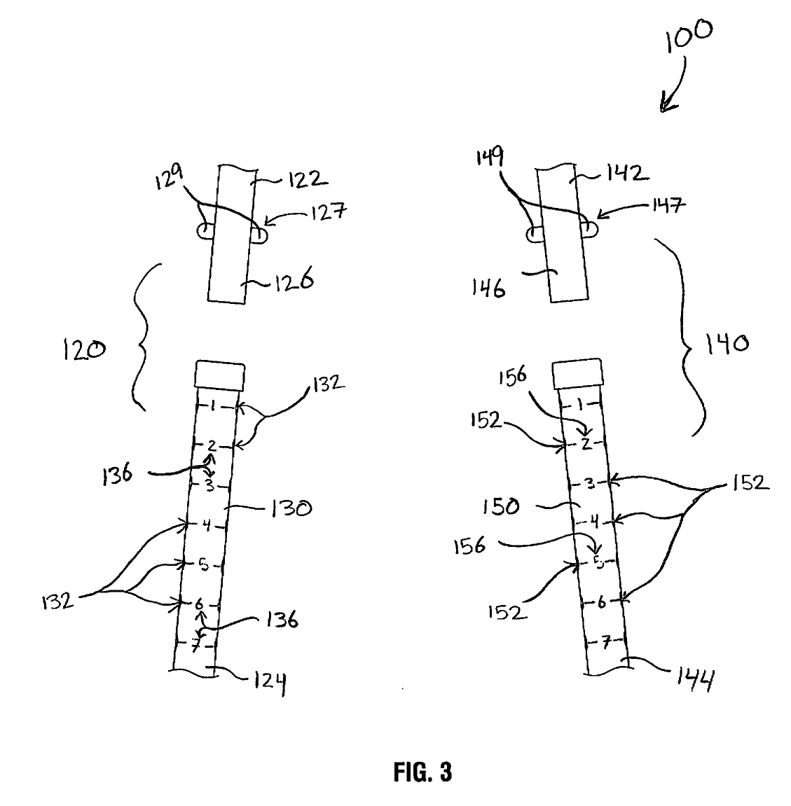

Turning now to FIGS. 3-10, side frame 100 is shown in various configurations, as will be described in greater detail below. Side frame 200 (FIGS. 1-2) is substantially similar to side frame 100 and, thus, is not shown to avoid unnecessary repetition. However, it is understood that side frame 200 (FIGS. 1-2) may include any (or all) of the features of side frame 100 described hereinbelow.

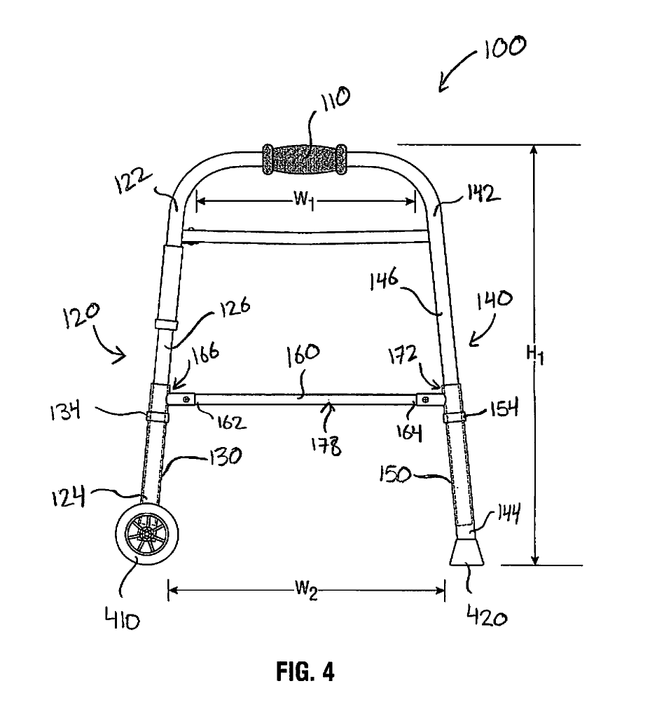

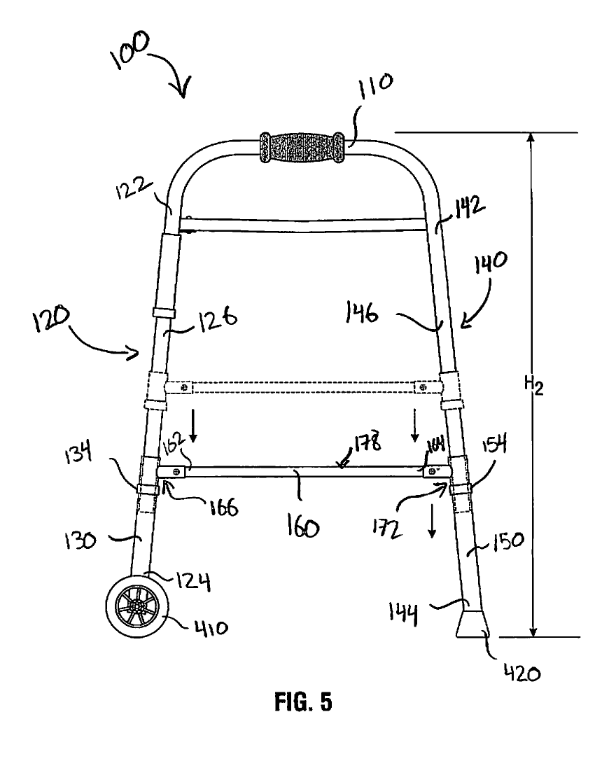

As shown in FIG. 3, front and rear legs 120, 140, respectively, of side frame 100 each include an inner shaft 126, 146 disposed toward respective fixed ends 122, 142 thereof and an outer shaft 130, 150, respectively, disposed toward respective free ends 124, 144 thereof. More particularly, inner shafts 126, 146 are slidable within respective outer shafts 130, 150, i.e., the inner and outer shafts 126, 146, and 130, 150, respectively, are translatable with respect to one another, between a substantially overlapping, or retracted position (see FIG. 4) wherein side frame 100 defines a minimum height, and an extended position (see FIG. 5), wherein side frame 100 defines a maximum height.

With continued reference to FIG. 3, each outer shaft 130, 150 may include a plurality of apertures 132, 152 respectively, defined therethrough and extending therealong, while inner shafts 126, 146, may each include a complementary locking pin 127, 147, e.g., spring biased locking pins 127, 147, that is configured and dimensioned for releasable engagement within each aperture 132, 152 of the corresponding outer shaft 130, 150, respectively. Accordingly, inner and outer shafts 126, 146 and 130, 150 of respective front and rear legs 120, 140 may be releasably secured in a plurality of incremental positions, such that side frame 100 may be adjusted incrementally between the substantially retracted position (see FIG. 4) wherein side frame 100 defines a minimum height, and the extended position (see FIG. 5), wherein side frame 100 defines a maximum height. Outer shafts 130, 150 may also include an annular cuff 134, 154, respectively, disposed at an end thereof, the functionality of which will be described in greater detail below.

As can be appreciated, the above-described configuration allows walker 10 to be adjusted according to the specific height of the user, or simply to adjust walker 10 to a desired height. In use, tabs 129, 149, of locking pins 127, 147, respectively, are squeezed inwardly against the bias until tabs 129, 149, are substantially disposed within inner shafts 126, 146, respectively. From this position, inner shafts 126, 146, may be slid with respect to outer shafts 130, 150 into position adjacent the aperture 132, 152 corresponding to the desired height, or position of walker 10. As tabs 129, 149 are moved adjacent the desired aperture 132, 152, tabs 129, 149 are released, permitting respective locking pins 127, 147, to return, under the spring-bias, to the outward, or initial position wherein tabs 129, 149 extend through apertures 132, 152, respectively, locking inner shafts 126, 146 and outer shafts 130, 150, respectively, in fixed position relative to one another. However, it is envisioned that other releasable securement mechanisms (not shown) may be provided for incrementally (or continuously) fixing the position of inner shafts 126, 146, with respect to outer shafts 130, 150 and, thus, for fixing the height of walker 10.

With continued reference to FIG. 3, outer shafts 130, 150 of legs 120, 140 may include markings 136, 156 to facilitate proper adjustment of legs 120, 140. Markings 136, 156 may denote the resultant height of walker 10 corresponding to the engagement of locking pins 127, 147 with that particular aperture 132, 152, respectively, or may be numerically, alphabetically or otherwise marked. Further, apertures 132, 152, of respective outer shafts 130, 150 may be equally spaced (at greater or shorter distances than as shown in FIG. 3) or may be un-equally spaced.

With reference to FIGS. 4 and 5, the adjustment of side brace 160 of side frame 100 will be described. As shown in FIG. 4, and as mentioned above, front and rear legs 120, 140 of side frame 100 are shown disposed in the substantially retracted position, wherein side frame 100 defines a minimum height “H₁.” In FIG. 5, on the other hand, front and rear legs 120, 140, respectively, of side frame 100 have been extended to the extended position, wherein side frame 100 defines a maximum height “H₂,” although front and rear legs 120, 140 may be extended to any of the intermediate positions as well. Further, as best shown in FIG. 4, due to the “A”-shaped, or oblique configuration of side frame 100, legs 120, 140 are angled away from one another such that legs 120, 140, define a first width “W₁” at fixed ends 122, 142 thereof (e.g., toward handle portion 110) and define a second, greater width “W₂” at free ends 124, 144 thereof.

With continued reference to FIGS. 4 and 5, side brace 160 includes front and rear connectors, or sleeves 166, 172 positioned about and slidable with respect to front and rear legs 120, 140, respectively. Side rail 178 of side brace 160 extends transversely between front and rear legs 120, 140 and is coupled at front end 162 thereof to front sleeve 166 and at rear end 164 thereof to rear sleeve 172. Due to the “A”-shaped, or oblique configuration of legs 120, 140, side rail 178 is necessarily adjustable, as will be described in greater detail below, such that a length of side brace 160 may be adjusted in accordance with the change in width between legs 120, 140, e.g., from first width “W₁” to second width “W₂,” as side brace 160 is translated, i.e., moved upwardly or downwardly, with respect to side frame 100.

As shown in FIGS. 4 and 5, sleeves 166, 172, of side brace 160, may be positionable adjacent respective annular cuffs 134, 154 of outer shafts 130, 150 of legs 120, 140. More specifically, annular cuffs 134, 154, define a seat, or shelf upon which sleeves 166, 172, of side brace 160 may sit, or rest. Annular cuffs 134, 154 are specifically positioned to align side brace 160 in position for providing sufficient stability and support to side frame 100, regardless of the selected, or adjusted height of side frame 100. The ability to slide and properly position side brace 160 provides sufficient stability and support to walker 10 by permitting side brace to remain generally centrally located along a height of side frame 100, as opposed to fixed-frame walkers, which may have a reduced range of heights and/or may have reduced stability and support, especially toward the upper limits of the range of heights. Annular cuffs 134, 154 further obviate the need to guess or estimate the proper positioning of side brace 160 with respect to the adjusted height of walker 10. Rather, the user may simply slide side brace 160 into position adjacent annular cuffs 134, 154 which act as a guide or mark for the proper positioning of the side brace 160 as dependent on the height of side frame 100. However, it is also contemplated that sleeves 166, 172 of side brace 160 be positioned spaced-apart from annular cuffs 134, 154, respectively, as may be required according to a user's particular needs. Accordingly, as will be described in greater detail below, latching mechanisms may be provided for fixing the relative position of side brace 160 with respect to legs 120, 140 (adjacent or spaced-apart from the annular cuffs 134, 154).

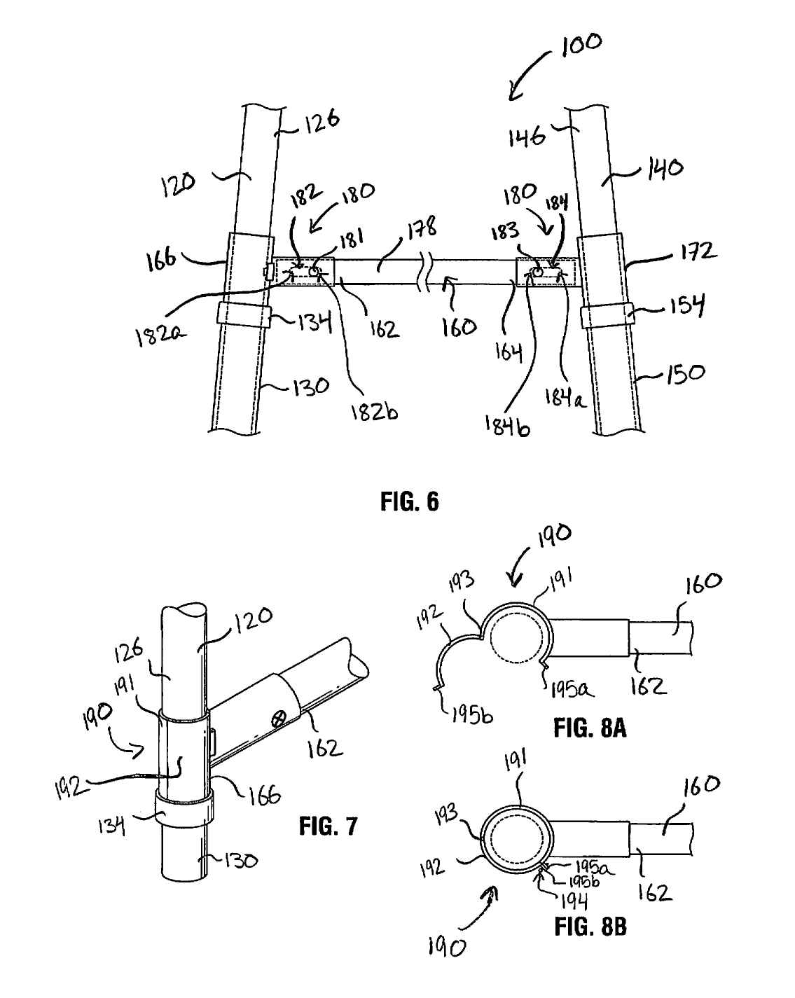

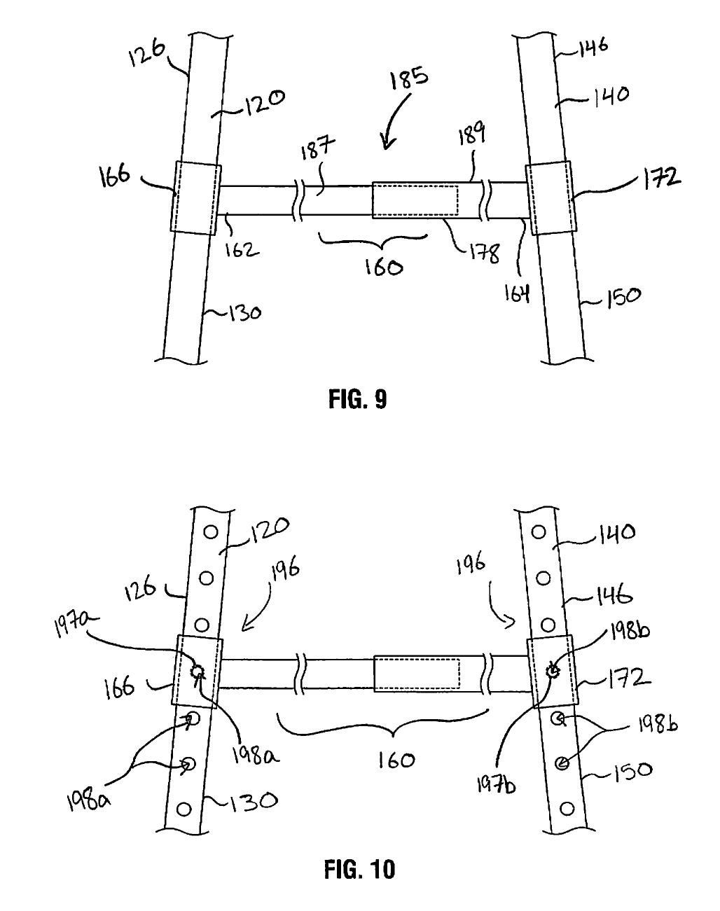

With reference now to FIGS. 6 and 9, two adjustment mechanisms 180 (FIG. 6) and 185 (FIG. 9) are shown configured for use with side brace 160 for adjusting the width of side brace 160, although other adjustment mechanisms (not shown) are also contemplated. As shown in FIG. 6, side rail 178 includes a pin, or cam member 181, 183, protruding outwardly from an outer peripheral surface thereof at each of the first and second ends 162, 164 of side rail 178. Each pin 181, 183 is disposed within a slot 182, 184 defined within respective connectors, or sleeves 166, 172, although it is envisioned that only one end 162 or 164, of side brace 160 include the pin/slot feature of adjustment mechanism 180.

The engagement of pins 181, 183 within respective slots 182, 184 secures side rail 178 to sleeves 166, 172, and, thus to legs 120, 140 and also permits expansion and contraction of side brace 160 between a first, or minimum width, i.e., where pins 181, 183 are disposed at outer-most ends 182a, 184a of slots 182, 184 and a second, or maximum width, i.e., where pins 181, 183 are translated along slots 182, 184 to the inner-most ends 182b, 184b, of slots 182, 184, respectively. As can be appreciated, the length of each slot 182, 184 defines the range of expansion/contraction, i.e., the range of widths, of side brace 160.

FIG. 9 shows another adjustment mechanism 185 wherein side rail 178 of side brace 160 include first and second shafts 187, 189, respectively that are telescopically moveable with respect to one another to expand and/or contract side brace 160 to a desired length. More specifically, side rail 178 is moveable between a contracted position defining a minimum length, e.g., “W₁,” when first and second shafts 187, 189 are substantially overlapping, i.e., wherein first and second shafts 187, 189 are disposed in a retracted position, and an expanded position defining a maximum length, e.g., “W₂,” when first and second shafts 187, 189 are substantially spaced from one another.

In use, front and rear legs 120, 140 are first adjusted, or expanded to the desired position, or height. Next, side brace 160 is translated downwardly (or upwardly) with respect to legs 120, 140 into position, e.g., adjacent annular cuffs 134, 154 of respective outer shafts 130, 150 of legs 120, 140, respectively, and is simultaneously expanded (of contracted) to conform to the width between legs 120, 140, e.g. from width “W₁” to width “W₂,” such that side frame 100 and, thus, walker 10, maintains its structural support and stability regardless of the height of walker 10.

Turning now to FIGS. 7, 8A-8B and 10, two latching mechanisms 190 (FIGS. 7-8B) and 196 (FIG. 10) are shown configured for use with side brace 160 to fix the relative position of side brace 160 with respect to legs 120, 140 of side frame 100 of walker 10. Latching mechanism 190 is disposed at first end 162 of side brace 160, although latching mechanism 190 may be disposed at second end 164 of side brace 160 (or, alternatively, a latching mechanism 190 may disposed at each of first and second ends 162, 164 of side brace 160). Latching mechanism 190 includes first and second semi-annular portions 191, 192, respectively, that are hingably coupled to one another via hinge 193. Latching mechanism 190 is moveable between an open position (FIG. 8A) and a closed position (FIG. 8B). In the open position, side brace 160 is translatable, or slidable with respect to legs 120, 140. In the closed position, first and second portions 191, 192 cooperate to form, or complete sleeve 166 (see FIG. 1) about front leg 120 to fix the relative position of side brace 160 with respect to legs 120, 140. Lock key 194 is engagable within apertures (not explicitly shown) defined through opposing flanges 195a, 195b of first and second portions 191, 192, respectively, to fix, or lock latching mechanism 190 in the closed position, as best shown in FIG. 8B, thereby fixing the relative position of side brace 160.

Latching mechanism 196, as shown in FIG. 10, includes a lock pin 197a, 197b disposed on and extending inwardly from each of sleeves 166, 172. Each lock pin 197a, 197b is selectively engagable with a plurality of apertures 198a, 198b, respectively, defined through respective inner shafts 126, 146 of legs 120, 140, respectively, of side frame 100. As can be appreciated lock pins 197s, 197b are depressible to disengage from apertures 198a, 198b in order to move, or reposition side brace 160 along front and rear legs 120, 140 of side frame 100 of walker 10. When the desired position is achieved, lock pins 197a, 197b may be released, allowing lock pins 197a, 197b, to engage, or lock into position within an adjacent aperture 198a, 198b.

From the foregoing and with reference to the various figure drawings, those skilled in the art will appreciate that certain modifications can also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. An adjustable walker, comprising:
first and second side frames coupled to one another, each side frame including:
a front leg defining a fixed end and a free end and a rear leg defining a fixed end and a free end, the front and rear legs coupled to one another at the fixed ends thereof, each of the front and rear legs extendable between a first position defining a first length and a second position defining a second length greater than the first length, each of the front and rear legs including a locking mechanism for releasably fixing the front and rear legs in at least the first and second positions; and
a side brace coupled at a first end thereof to the front leg and coupled at a second end thereof to the rear leg, the side brace including a side rail extending transversely between the front and rear legs, the side brace moveable along the front and rear legs between the fixed ends and the free ends thereof, the side brace including a latching mechanism disposed at one of the first and second ends thereof for releasably fixing the position of the side brace with respect to the front and rear legs.

2. The adjustable walker according to claim 1, wherein each of the front and rear legs includes an inner shaft and an outer shaft moveable with respect to the inner shaft between a substantially retracted position and an extended position to move the front and rear legs between the first and second positions.

3. The adjustable walker according to claim 2, wherein the locking mechanism includes a plurality of apertures defined within the outer shaft of each of the front and rear legs and positioned along a length thereof and a locking pin disposed on the inner shaft of each of the front and rear legs, the locking pin engagable within each of the apertures for selectively fixing the position of the inner and outer shafts with respect to one another at a plurality of incremental positions.

4. The adjustable walker according to claim 2, wherein a first end of the outer shaft of each of the front and rear legs includes an annular cuff disposed therearound.

5. The adjustable walker according to claim 4, wherein the side brace is positionable adjacent the annular cuffs of the front and rear legs such that the side brace is positionable in a specific pre-determined position along the front and rear legs depending on the length of the front and rear legs.

6. The adjustable walker according to claim 1, wherein the latching mechanism includes first and second portions hingable with respect to one another between an open position and a closed position, the first and second portions annularly positionable about one of the front and rear legs when in the closed position to fix the relative position of the side brace with respect to the front and rear legs.

7. The adjustable walker according to claim 6, wherein the latching mechanism includes a locking key for retaining the first and second portions in the closed position.

8. The adjustable walker according to claim 1, wherein the free end of the front leg includes a wheel coupled thereto.

9. The adjustable walker according to claim 1, wherein the first and second side frames are coupled to one another by a front cross-bar.

10. The adjustable walker according to claim 1, further comprising a handle portion fixedly engaging the fixed ends of the front and rear legs to one another.

11. The adjustable walker according to claim 1, wherein the front and rear legs are angled with respect to one another such that the fixed ends of the front and rear legs are spaced-apart a first transverse distance with respect to one another and such that the free ends of the front and rear legs are spaced-apart a second transverse distance with respect to one another, the second transverse distance being greater than the first transverse distance.

12. The adjustable walker according to claim 11, wherein the side brace is adjustable between a first position having a first length corresponding to the first transverse distance and a second position having a second length corresponding to the second transverse distance.

13. The adjustable walker according to claim 12, wherein the side brace is configured for automatic adjustment to define a length of the side brace corresponding to a distance between the front and rear legs upon movement of the side brace along the front and rear legs.

14. The adjustable walker according to claim 11, wherein the side brace further includes a pair of connectors coupling the side brace to each of the front and rear legs, the side rail of the side brace interconnecting the connectors, the side rail being moveable with respect to at least one of the connectors between a first position corresponding to the first length of the side brace and a second position corresponding to the second length of the side brace.

15. The adjustable walker according to claim 14, wherein the side rail includes a pin disposed within a slot defined within the at least one connector, the pin moveable from a first end of the slot to a second end of the slot such that the side rail is moveable between the first position and the second position.

16. The adjustable walker according to claim 11, wherein the side rail of the side brace includes an inner portion and an outer portion, the inner and outer portions moveable relative to one another to adjust the length of the side brace.

17. An adjustable walker, comprising:
first and second side frames coupled to one another, each side frame defining a generally “A”-shaped configuration and including:
a handle portion, a front leg, a rear leg, and a side brace, the front and rear legs extendable between a first position defining a first height of the side frame and a second position defining a second height of the side frame that is greater than the first height, the side brace coupled to the front and rear legs and extending transversely therebetween, the side brace moveable with respect to the front and rear legs along the height thereof, the side brace adjustable between a first position defining a first length corresponding to a first transverse distance between the front and rear legs and a second position defining a second length corresponding to a second transverse distance between the front and rear legs that is greater than the first distance.

18. The adjustable walker according to claim 17, wherein the side brace of each side frame includes a latching mechanism for releasably fixing the position of the side brace with respect to the front and rear legs.

19. The adjustable walker according to claim 17, wherein the side brace of each side frame includes a side rail and a pair of connectors, the side rail including a pin disposed within a slot defined within at least one of the connectors, the pin moveable from a first end of the slot to a second end of the slot such that the side brace is adjustable between the first position and the second position.

20. The adjustable walker according to claim 17, wherein the side brace of each side frame includes a side rail having an inner portion and an outer portion, the inner and outer portions moveable with respect to one another to adjust the side brace between the first and second positions.
